(19) United States
(12) Patent Application Publication
(10) Pub. No.: US 2011/0203685 A1
(43) Pub. Date: Aug. 25, 2011

(54) APPARATUS TO DETERMINE A POSITION OF A VALVE

(76) Inventors: Chun Lin, McKinney, TX (US); Roy Ronald Pelfrey, Sherman, TX (US)

(21) Appl. No.: 13/079,540

(22) Filed: Apr. 4, 2011

Related U.S. Application Data
(63) Continuation of application No. PCT/US2009/054620, filed on Aug. 21, 2009.

(51) Int. Cl. F16K 37/00

(52) U.S. Cl. 137/553

(57) ABSTRACT

Methods and apparatus to indicate a position of a valve are described. An example position indicator apparatus includes a status indicator to provide an indication that corresponds to a displacement of a poppet relative to a seat ring of the fluid valve to determine one of a plurality of predetermined operational positions of the fluid valve. A follower is coupled to the poppet to follow movement of the poppet between the plurality of predetermined operational positions of the fluid valve. A coupler operatively couples the status indicator and the follower.

### CROSS-REFERENCE TO RELATED APPLICATIONS

The patent arises from a continuation of International Patent Application Serial Number PCT/US2009/054620, filed on Aug. 21, 2009, titled “Apparatus to Determine a Position of a Valve,” which claims the benefit of the filing date of U.S. patent application Ser. No. 12/247,838, filed on Oct. 8, 2008, both of which are incorporated herein by reference in their entireties.

### FIELD OF THE DISCLOSURE

The present disclosure relates generally to valves and, more particularly, to apparatus to determine a position of a valve.

### BACKGROUND

Internal, self-closing stop valves which are commonly referred to as internal valves, provide protection against discharge of hazardous materials, compressed liquids, and/or gases such as, for example, propane, butane, NH3 (anhydrous ammonia), etc., when transferring the hazardous material between a first location and a second location. Internal valves employ flow control mechanisms that will close in response to a sudden excess flow condition due to, for example, a broken, severed, or otherwise compromised flow path. Such flow control mechanisms are commonly referred to as excess flow valves, which are often used in applications requiring an automatic, safe cutoff of fluid flow in response to potential leaks, spills, etc. of potentially dangerous (e.g., combustible, toxic) fluids.

An internal valve typically includes an excess flow function or integrated excess flow valve that closes when a flow through the internal valve exceeds an established flow rating. For example, an internal valve installed on a cargo tank typically provides protection against the discharge of hazardous materials during an unloading operation in the event that a pump and/or piping attached to the internal valve is sheared off and/or otherwise breached. Similarly, an internal valve installed on a stationary tank provides protection against the discharge of hazardous materials in the event that a pump and/or piping attached to the internal valve is sheared off and/or otherwise breached.

Such internal valves may be designed to operate automatically, free from external control and dependent solely or primarily on system conditions (e.g., pressure values). While these internal valves are safeguarded from certain dangers (e.g., mechanical damage from external impact), the limited access to such valves often makes it difficult or impossible to determine the position or the operational state (e.g., an open position, a closed position, a bleed state position, etc.) of the valve.

### SUMMARY

In one example, a valve position indicator apparatus includes a status indicator to provide an indication that corresponds to a displacement of a poppet relative to a seat ring of the fluid valve to determine one of a plurality of predetermined operational positions of the fluid valve. A follower is coupled to the poppet to follow movement of the poppet between the plurality of predetermined operational positions of the fluid valve. A coupler operatively couples the status indicator and the follower.

In another example, a valve position indicator apparatus includes a poppet disposed within a fluid flow passageway of the fluid valve and moveable between at least a first position to allow fluid flow through the passageway and a second position to restrict fluid flow through the passageway and a follower coupled to the poppet. A sensor is operatively coupled to the follower such that rectilinear displacement of the follower between the first and second positions is to cause the sensor to rotate between at least a third position and a fourth position where the third position corresponds to the first position and the fourth position corresponds to the second position.

### BRIEF DESCRIPTION OF THE DRAWINGS

FIG. 1 illustrates an example valve described herein.

FIG. 2 is a cross-sectional view of the example valve of FIG. 1.

FIG. 3 illustrates a partial cutaway view of a portion of the example valve of FIGS. 1 and 2.

FIG. 4 illustrates another partial cutaway view of a portion of the example valve of FIGS. 1 and 2.

### DETAILED DESCRIPTION

The example valve position indicator apparatus and methods described herein detect a position or operational state of a flow control apparatus such as, for example, an internal valve or self-closing stop valve. Typically, internal valves open or close based on a pressure and/or fluid flow rate of a system in which the internal valve is coupled to or installed. As a result, when operating a system employing an internal valve having an integral excess flow valve, it is typically necessary to equalize the pressure between the valve inlet and outlet before fluid is pumped through the valve. However, in some cases, the valve position or status (e.g., an open position, a closed position, an intermediate position, etc.) is not always clear to an operator.

Where the position of a valve is not available or clear, an operator may be forced to employ manual methods (, operator intervention or involvement may be required) to operate the control system in which the valve is installed. Such an approach may be inefficient if, for example, several attempted equalizations are performed due to operator error. For example, without knowledge of the position or operational status of the internal valve (e.g., whether the pressure is equalized) the operator may, for example, prematurely begin to pump fluid based on an estimation of whether the valve is equalized, thereby causing the valve to close and prevent the flow fluid through the valve.

In contrast to known internal valves, the example valve position indictor apparatus described herein determine or provide a position or operational status of the internal valve that may otherwise remain unknown to system operators and/or any other persons or equipment associated with the system. More specifically, the example valve position indicator apparatus described herein provide signals to detect one of a plurality of predetermined or distinct operational positions of an internal valve or excess flow control valve. Such signals may include, for example, a mechanical signal, an electrical signal, an audio signal, a visual signal, etc., and/or any other suitable signal. Additionally or alternatively, an operator may utilize the position information to operate, troubleshoot, test, and/or otherwise manipulate the system. For example, in a system that employs multiple internal valves, an operator may quickly troubleshoot or determine if a valve becomes stuck in an open position.

In one example, an example valve position indicator apparatus described herein includes a follower operatively coupled to a flow control member to detect the operational position of the flow control member. The follower generates or provides a signal to a position indicator operatively coupled to the follower. The position indicator correlates to the position of the flow control member and corresponds to one of a plurality of predetermined or distinct operational states of the valve such as, for example, an open position, a closed position, an intermediate position, etc. An example apparatus described herein includes a mechanical display to communicate the operational position of the valve to an operator. The example apparatus described herein may be factory installed or may be retrofit to existing valves in the field.

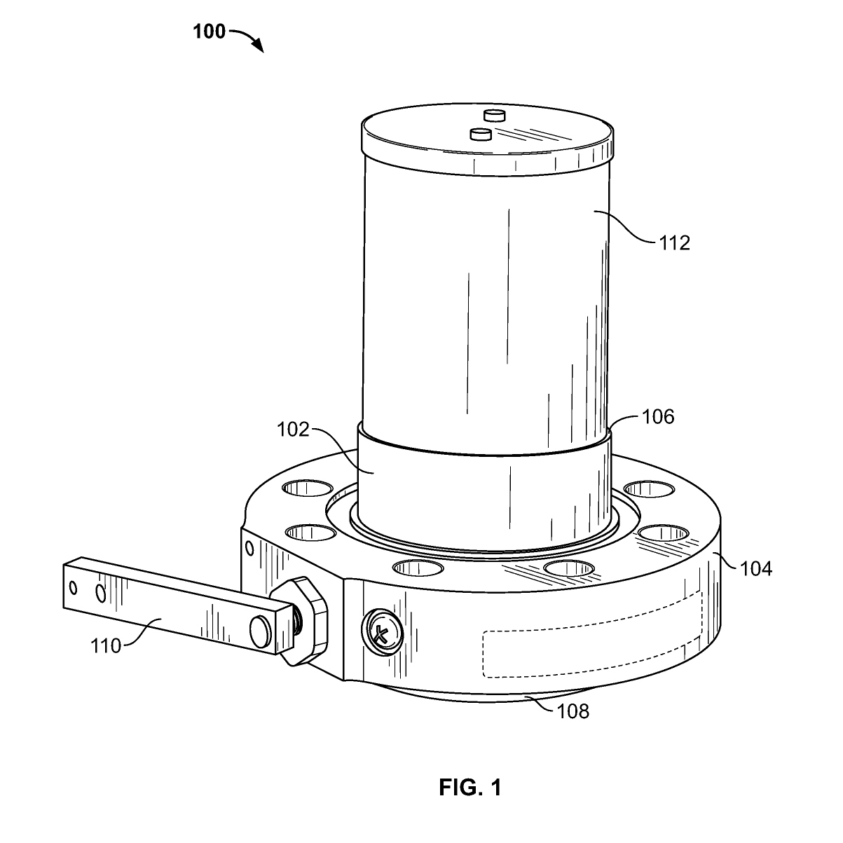

FIG. 1 illustrates an example valve 100 described herein. The example valve 100 is depicted as a self-closing stop valve such as, for example, an internal valve. The valve 100 includes a body 102 having a flanged portion 104 for coupling or mounting the example valve 100 to a piping system, a storage tank, a bobtail truck system, or any other suitable distribution system. In other examples, the body 102 may include a double flanged portion or a threaded outer portion to couple or mount the valve 100 to a system (, a tank). Although the example valve 100 is depicted as an internal valve, the valve position indicator apparatus described herein may be implemented with any other suitable flow control apparatus and/or valve(s).

The body 102 has a first end or inlet 106 in fluid communication with a first or upstream pressure source (, a pipeline or a tank) at which relatively high pressure process fluid is presented and a second end or outlet 108 in fluid communication to a second or downstream pressure source (, a pump, a piping, a hose, etc.) to which the example valve 100 provides the process fluid. For example, the first pressure source may include a tank containing a pressurized gas or liquid to be delivered to a destination via, for example, the valve 100. In other words, the inlet 106 of the valve 100 may be surrounded by relatively high pressure fluid.

The outlet 108 of the valve 100 may be disposed outside of the first pressure source to receive a hose, a pipe, or any other suitable fluid transport component. In other words, fluid flows from the first pressure source to a transport component (, a hose) via the valve 100 to a destination (e.g., another storage tank and/or additional process control elements).

The example valve 100 operates between at least a first operating position and a second operating position in which the valve 100 is closed and opened, respectively. In the illustrated example, the example valve 100 includes a third operating position or bleed position that may be selected by an operating lever 110 as described below. The lever 110 may be operated manually to open and close the example valve 100. In other examples, the lever 110 may be operated via cable controls, a linkage mechanism, or an actuator (, air cylinder), etc. The example valve 100 may also include a strainer 112 coupled to the body 102 to filter unwanted particles or contaminates from the fluid as the fluid flows from the inlet 106 to the outlet 108 of the valve 100.

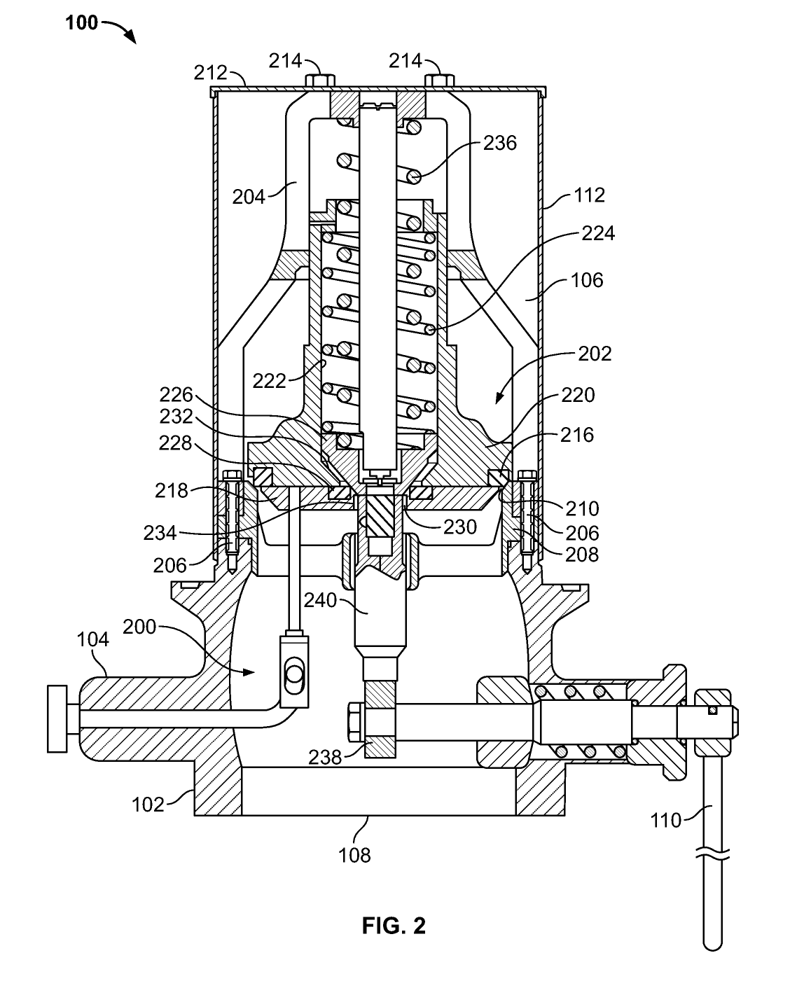

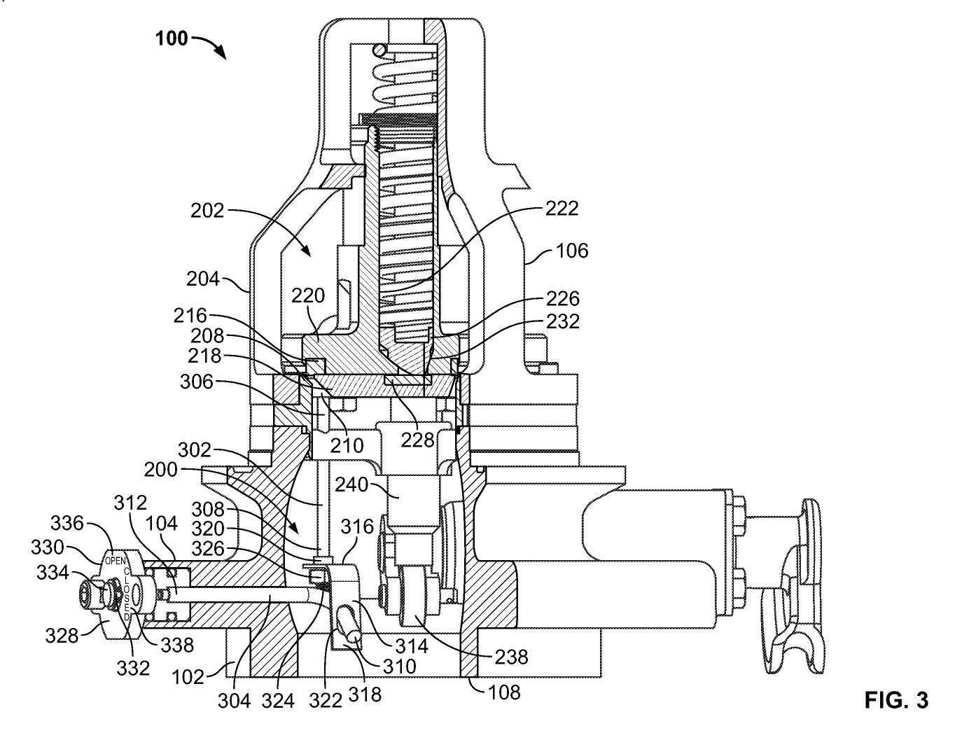

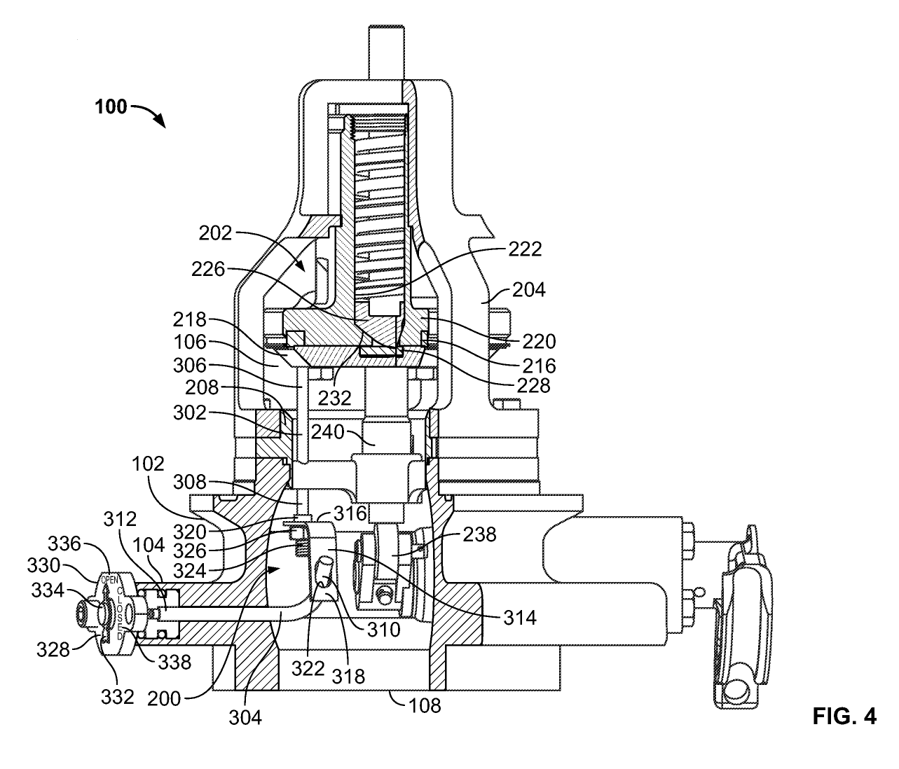

FIG. 2 illustrates a cross-sectional view of the example valve 100 of FIG. 1 implemented with an example valve position indicator apparatus 200 described herein. The example valve position indicator apparatus 200 described herein determines the operational position or state of the valve 100 (, an open position, a closed position) and conveys the position status of the valve 100 to, for example, an operator. The example valve position indicator apparatus 200 is described in greater detail below in connection with FIGS. 3 and 4. The example valve position indicator apparatus 200 is operatively coupled to a flow control member or main poppet 202, which opens and closes to control the fluid flow rates through the body 102 of the valve 100. A cage 204 supports the main poppet 202 and is coupled to the body 102 via fasteners 206. The body 102 is the main pressure boundary of the valve 100 and supports a seating surface or seat ring 208 that is mounted in the body 102 and defines an orifice 210 that provides a fluid flow passageway to establish communication between the inlet 106 and the outlet 108 when the main poppet 202 is moved away from the seat ring 208. A retainer 212 couples the strainer 112 to the body 102 via fasteners 214.

In the illustrated example, the main poppet 202 is depicted as a disc-type valve assembly that includes a disc 216 (e.g., a metal disc, a rubber disc, etc.) that engages the seat ring 208 to restrict the flow of fluid through the valve 100. A disc retainer 218 couples the disc 216 to a disc holder 220 (e.g., via screws), which includes an aperture 222 defining a bleed flow path. A biasing element 224 such as, for example, a spring, is disposed within the aperture 222 and biases the main poppet 202 toward the seat ring 208 to restrict the fluid flow through the orifice 210 when the flow rate through the valve exceeds a specified or predetermined flow rate.

To accomplish the fluid control, the valve 100 includes an equalization member 226 (e.g., a valve plug) disposed within the aperture 222 of the disc holder 220 to engage a bleed disc 228 coupled to the disc retainer 218 to restrict the flow of fluid through a bleed port 230. The bleed port 230 provides a fluid flow passageway between the inlet 106 and the outlet 108 and is formed by a reduced diameter portion or tapered portion 232 of the aperture 222 and an aperture 234 of the disc retainer 218. Furthermore, a biasing element 236 (e.g., a spring) along with the pressure of the first pressure source biases the equalization member 226 toward the bleed disc 228 (e.g., in a closed position) to restrict flow of fluid through the bleed port 230 when the lever 110 is in a first position. A cam 238 operatively coupled to the lever 110 engages a stem 240 coupled to the equalization member 226 when the lever 110 is rotated from the first position to a second position to cause the equalization member 226 to move away from the disc seat 228 to allow fluid to flow from the inlet 106 or first pressure source to the outlet 108. The second position may be an intermediate position between a closed position and an open position of the equalization member 226. In the intermediate position, the stem 240 may include a rapid bleed portion (e.g., a reduced diameter) to allow a relatively high bleed flow rate through the bleed port 230.

Referring to FIGS. 3 and 4, the example valve position indicator apparatus 200 includes a follower or linear member 302 operatively coupled to a status indicator or rotational member 304. The linear member 302 is coupled to the main poppet 202 at a first end 306 and operatively coupled to the rotational member 304 at second end 308. The linear member 302 includes an elongated member or rod that may be integrally formed with the main poppet 202 and/or may be fastened to the main poppet 202 via screws, clips, rivets and/or any other suitable mechanical or chemical fastener(s). The linear member 302 is linearly displaced between a first position and a second position that correlate to a first operating position (e.g., a closed position) and a second operating position (e.g., an open position) of the main poppet 202. In other words, the linear member 302 follows the movement (e.g., rectilinear displacement) of the main poppet 202 relative to the seat ring 208 to sense or indicate the operational position of the main poppet 202 relative to the seat ring 208.

The rotational member 304 provides a signal or an indication that correlates to the operational position of the main poppet 202 relative to the seat ring 208. The rotational member 304 rotates between a first position and a second position that correlate with the first and the second positions of the linear member 302. The rotational member 304 includes an elongated member or rod having a first end 310 substantially perpendicular, bent, angled, or curved relative to a second end 312.

In the illustrated example, a coupling member 314 couples the linear member 302 to the rotational member 304. In the example, the coupling member 314 is depicted as a bracket, but may be any other suitable connector such as, for example, a clip connector, a tang-like connector, yoke connector, etc. The coupling member 314 includes a first portion 316 that is substantially perpendicular or curved relative to a second portion 318. The first portion 316 includes an aperture 320 to receive the second end 308 of the linear member 302 and the second portion 318 includes a slot 322 to receive the first end 310 of the rotational member 304. In the illustrated example, the second end 308 of the linear member 302 includes a threaded portion 324 that couples to the coupling member 314 via a fastener 326 and the first end 310 of the rotation member 304 engages the slot 322. However, in other examples, the linear member 302 and/or the rotational member 304 may be coupled to the coupling member 314 in any other suitable manner(s). In yet other examples, the linear member 302 includes a tang-like connector integrally formed at the second end 308 to operatively couple the linear member 302 to the rotational member 304.

A sensor or indicator such as, for example, a display 328 may be disposed on an outer surface 330 of the body 102 to communicate to an operator the operational state of the valve 100. In the illustrated example, the display 328 is a visual, mechanical signal that includes a pointer 332 coupled to the second end 312 of the rotational member 304 via a fastener 334. The pointer 332 rotates along with the rotational member 304 which, in turn, rotates between the first and second positions that correlate to the operational position of the main poppet 202 via the linear member 302 and provides the position of the valve 100. As more clearly shown in FIGS. 3 and 4, the display 328 may include visual indicators or text 336 and 338 to indicate the operational position of the example valve 100 such as, for example, an opened position or a closed position. In other examples, the display 328 may include a digital display to indicate the operational position of the valve 100. Additionally or alternatively, a sealing member such as, for example, an o-ring, a chevon packing mechanism, and/or any other suitable sealing member may be disposed between the rotational member 304 and the body 102 to prevent undesired leakage along the rotational member 304.

In other examples, the valve position indicator apparatus 200 may include a rack and pinion gear assembly to determine the operational position of the valve 100. For example, a portion of the linear member 302 may include a rack gear and the rotational member 304 may include a pinion gear. In other examples, the sensor 328 may be a pneumatic sensor, a hydraulic sensor, an electrical sensor, and/or any other suitable sensors that provide output signals that sense and/or provide an indication of the operational position of the valve 100. For example, an electronic position transmitter may be coupled to the valve 100 to determine displacement (e.g., rectilinear displacement) of the main poppet 202 and transmit an electrical signal output (e.g., via wiring or a wireless connection) corresponding to the displacement of the main poppet 202, which correlates to one of the plurality of operating position of the valve 100. In yet other examples, the output signal may include an audio signal to indicate to an operator that the valve 100 is in the open position and/or the close position.

In operation, the main poppet 202 and the equalization member 226 are biased toward the closed position by the biasing element 236 and the pressure of the first pressure fluid source at the inlet 106 of the valve 100. FIGS. 3 and 4 illustrate the example valve 100 in the first operational position (e.g., the closed position) and the second operational position (e.g., the open position), respectively. The equalization member 226 and the main poppet 202 provide an excess flow functionality that maintains system safety. More specifically, the excess flow function protects the system (e.g., fluid delivery system, etc.) by automatically restricting fluid flow from the inlet 106 when a flow rate becomes too high. In other words, the biasing element 224 causes the poppet 202 move toward the seat ring 208 when the flow rate across the valve exceeds a specific or predetermined flow rate.

The main poppet 202 operates based on a pressure differential between the inlet pressure and the outlet pressure of the valve 100. When the inlet pressure is substantially greater than the outlet pressure, the main poppet 202 remains biased toward the seat ring 208 in a closed position (FIG. 3). On the other hand, when the inlet pressure is approximately equal to the outlet pressure, the main poppet 202 opens to allow fluid to flow through the valve 100 at a relatively high rate (FIG. 4). The equalization member 226 is used to equalize or balance the pressure between the inlet 106 and outlet 108. For example, the equalization member 226 may place the valve 100 in a bleed state that allows a certain amount of flow to equalize pressure across the valve 100, which in turn, opens the main poppet 202 to provide a relatively high fluid flow through the valve 100.

Referring to FIG. 3, the valve 100 is in the closed position as indicated by the position indicator 328. As stated above, in the closed position, the main poppet 202 engages the seat ring 208 to prevent fluid flow through the valve 100. When the poppet 202 is in the closed position, the linear member 302 displaces the coupling member 314 in a direction toward the outlet 108 which, in turn, causes the rotational member 304 to rotate the pointer 332 in a first direction toward a first position indicated by the close position 338. An operator may clearly determine that the valve 100 is in the close position via the position indicator 328.

To equalize the pressure across the valve 100 and, thus, open the valve 100 to allow fluid flow, the lever 110 is moved to a second position. Rotation of the lever 110 between the first position and the second position causes the cam 238 to rotate and displace the stem 240 in a direction toward the retainer 212. The displacement of the stem 240 causes the equalization member 226 to move away from the bleed disc 228 to allow fluid flow through the bleed port 230. Additionally, displacement of the stem 240 compresses the biasing elements 224 and 236 toward the retainer 212 so that the biasing elements 224 and 236 do not bias the main poppet 202 toward the seat ring 208.

As the fluid flows from the inlet 106 to the outlet 108 through the bleed port 230, the pressure differential across the valve 100 (e.g., the main poppet 202) substantially equalizes. Equalization of the pressure across the main poppet 202 causes the main poppet 202 to move away from the seat ring 208 and toward the retainer 212 to the open position. As the main poppet 202 moves to the open position, the linear member 302 follows the linear displacement of the main poppet 202. The linear displacement of the linear member 302 causes the coupling member 314 to move in a linear direction toward the retainer 212 which, in turn, causes the rotational member 304 to rotate the pointer 332 in a second direction toward a second position indicated by the open position 336. As shown in FIG. 4, an operator may clearly determine that the valve 100 is in the open position via the position indicator 328.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A valve position indicator apparatus for use with a fluid valve comprising:
a status indicator to provide an indication that corresponds to a displacement of a flow control member relative to a seat ring of the fluid valve to determine one of a plurality of predetermined operational positions of the fluid valve;
a follower coupled to the flow control member to follow movement of the flow control member between the plurality of predetermined operational positions of the fluid valve; and
a coupler to operatively couple the status indicator and the follower.

2. A valve position indicator apparatus of claim 1, wherein the coupler is to convert a rectilinear displacement of the follower into a rotational displacement of the status indicator to provide an indication that corresponds to one of the plurality of predetermined operational positions of the valve.

3. A valve position indicator apparatus of claim 1, wherein the coupler includes a first portion that is substantially perpendicular or curved relative to a second portion.

4. A valve position indicator apparatus of claim 3, wherein the first portion of the coupler includes an aperture to receive an end of the follower and the second portion of the coupler includes a slot to receive an end of the status indicator.

5. A valve position indicator apparatus of claim 1, wherein the follower comprises an elongate member having a first end coupled to the poppet and a second end operatively coupled to the status indicator via the coupler.

6. A valve position indicator apparatus of claim 5, wherein the first end of the follower is integrally formed with the flow control member as a substantially unitary piece or structure.

7. A valve position indicator apparatus of claim 1, wherein the status indicator has a first end that is substantially bent relative to a second end.

8. A valve position indicator apparatus of claim 7, wherein the first end of the status indicator is operatively coupled to follower via the coupler.

9. A valve position indicator apparatus of claim 1, further comprising a visual display operatively coupled to the status indicator to provide a position status of the fluid valve corresponding to the one of the plurality of predetermined operational positions of the fluid valve.

10. A valve position indicator apparatus of claim 9, wherein the visual display comprises a pointer coupled to the status indicator, wherein the status indicator rotates the pointer to a position corresponding to one of the plurality of predetermined operational positions of the fluid valve when the follower rotates the status indicator.

11. A valve position indicator apparatus of claim 1, wherein the one of the plurality of predetermined operational positions of the valve comprises an open position, a closed position, or an intermediate position.

12. A valve position indicator apparatus comprising:
a poppet disposed within a fluid flow passageway of the fluid valve and moveable between at least a first position to allow fluid flow through the passageway and a second position to restrict fluid flow through the passageway;
a follower coupled to the poppet; and
a sensor operatively coupled to the follower, wherein rectilinear displacement of the follower between the first and second positions is to cause the sensor to rotate between at least a third position and a fourth position, wherein the third position corresponds to the first position and the fourth position corresponds to the second position.

13. A valve position indicator apparatus of claim 12, wherein a first end of the follower is coupled to the poppet and a second end of the follower is operatively coupled to a third end of the sensor.

14. A valve position indicator apparatus of claim 13, further comprising a coupling member to couple the third end of the sensor and the second end of the follower.

15. A valve position indicator apparatus of claim 14, wherein the coupling member comprises an L-bracket.

16. A valve position indicator apparatus of claim 12, further comprising a visual display coupled to the sensor.

17. A valve position indicator apparatus of claim 16, wherein the visual display comprises a pointer coupled to a fourth end of the sensor.

18. A valve position indicator apparatus of claim 17, wherein the pointer is disposed on an outer surface of a body of the fluid valve to communicate the operational position of the poppet.

19. A valve position indicator apparatus comprising
means for following a rectilinear displacement of a flow control member of a valve relative to a valve seat;
means for indicating a position of the flow control member operatively coupled to the means for following; and
means for converting the rectilinear displacement of the means for following into rotational displacement of the means for indicating, wherein the rotational displacement of the means for indicating correlates with the rectilinear displacement of the flow control member relative to the valve seat.

20. A valve position indicator apparatus of claim 19, further comprising means for displaying the rotational displacement of the means for indicating, wherein the means for displaying correlates to one of a plurality of predetermined operational positions of the valve.
